(19) United States
(12) Patent Application Publication
(10) Pub. No.: US 2011/0240904 A1
(43) Pub. Date: Oct. 6, 2011

(54) SURFACTANT-FREE SYNTHESIS AND FOAMING OF LIQUID BLOWING AGENT-CONTAINING ACTIVATED CARBON-NANO/MICROPARTICULATE POLYMER COMPOSITES

(75) Inventors: Nan-Rong Chiou, Midland, OH (US); Ly James Lee, Columbus, OH (US); Jintao Yang, Columbus, OH (US); Shu-Kai Yeh, Columbus, OH (US)

(73) Assignees: THE OHIO STATE UNIVERSITY RESEARCH FOUNDATION, Columbus, OH (US); NANOMATERIAL INNOVATION LTD, Columbus, OH (US)

(21) Appl. No.: 12/995,042

(22) PCT Filed: May 28, 2009
(86) PCT No.: PCT/US09/45511

§ 371 Date: Jun. 19, 2011

Related U.S. Application Data
(62) Division of application No. 61/130,061, filed on May 28, 2008.

(51) Int. Cl. C08J 9/35; E04B 1/78; C08L 25/06; C08K 3/04; C08K 3/34

(52) U.S. Cl. 252/62

(57) ABSTRACT

Exemplary embodiments of the present invention relate to polystyrene and/or thermoplastic polymer or polymer blend composite foam or a foamable polymeric material precursor, which contains activated carbon and/or at least one of 1-dimensional, 2-dimensional, and 3-dimensional nano/micro-materials in polystyrene and/or thermoplastic polymer and/or polymer blend matrix to carry a co-blowing agent such as water without using any surfactant-like molecules and/or polymers, having or adapted to have the properties of low density, high-R value, good mechanical properties, and fire retardance thereof. Exemplary embodiments of the present invention include various manufacturing methods that may be employed including, but not limited to, extrusion, batch molding, and injection molding. One example includes synthesis and CO₂ and water-based extruded foaming of such a material.

This application claims the benefit of U.S. Provisional Application No. 61/130,061, filed May 28, 2008, which is hereby incorporated by reference in its entirety.

### TECHNICAL FIELD OF THE INVENTION

Exemplary embodiments of the present invention relate to polymeric foams and methods for their production and articles made therefrom.

### BACKGROUND AND SUMMARY OF THE INVENTION

With the soaring cost of energy, it is essential to develop new light-weight materials that can provide better thermal insulation performance in housing and construction industries and high structural strength for automotive, aerospace, and electronic applications.

For example, in the housing industry, doubling the ‘R’ value of current thermal insulation materials can save $200 million annually in heating/cooling costs for families in the U.S. In today's average vehicles, as much as 5-10% in fuel savings can be achieved through a 10% weight reduction. Polymeric foams have been used in many applications because of their excellent strength-to-weight ratio, good thermal insulation and acoustic properties, materials savings, and other factors. By replacing solid plastic with cells, polymeric foams use fewer raw materials and thus reduce the cost and weight for a given volume. The North American market for foamed plastic insulations exceeds $3 billion annually, while global demand is above $13 billion. However, polymer foams, except sandwich composite foams, are rarely used as structural components in the automotive, aerospace and construction industries because of poor mechanical strength and low dimensional and thermal stability, when compared to bulk polymers.

In recent years, several researchers have reported that foams can possess excellent mechanical strength if the cell size is smaller than the typical flaw size in bulk polymers, i.e., <10 μm. Microcellular foams can reduce material usage and improve mechanical properties simultaneously. They have been commercialized for some applications (i.e., MuCell by Trexel). However, they require specially designed processing equipment, have a narrow process window, and are still not good enough for structural applications.

Closed-cell plastic foams have better thermal insulation efficiency than glass fiber or plywood insulation materials, but the application of plastic foams in the housing industry is limited due to their poor fire resistance. A drastic reduction of thermal conductivity has been observed when the cell size is reduced to nanoscale, e.g., aerogel. These nanofoams are currently made of ceramics in thin films and are very expensive. Foams with ultra-low density also provide better thermal insulation. To increase the expansion ratio during foaming in order to achieve ultra-low density, an expensive vacuum system is often needed in the industrial foam extrusion line.

Another critical issue faced by the foam industry is the blowing agent. Traditional chlorofluorocarbon (CFC) and hydrochlorofluorocarbon (HCFC) blowing agents cause ozone depletion and will be banned by 2010 according to the Montreal Protocol. Carbon dioxide (CO₂) is an attractive replacement for the ozone-depleting blowing agents because it is low-cost, non-toxic, nonflammable, and not regulated by the Environmental Protection Agency (EPA). Since insulation foams used in houses dramatically reduce energy consumption and thus decrease the pollution generated by power plants, the use of CO₂ has both a direct and an indirect benefit to the environment. However, CO₂ has a lower solubility in most polymers than the traditional blowing agents. It also has a higher diffusivity leading to a quick escape from the foam after processing. While this ensures fast mixing, it also offers a quick escape from the foam after processing resulting in a lower expansion ratio (i.e., higher foam density). The presence of CO₂ complicates the manufacturing process and thus results in a high processing cost.

An exemplary embodiment of the present invention seeks to dramatically improve the insulation performance of polymer foams preferably using at least one blowing agent that has minimal impact on the environment (e.g., zero-ozone depleting blowing agents such as CO₂ and/or water). One exemplary embodiment of the present invention relates to polystyrene and/or thermoplastic polymer or polymer blend composite foam or a foamable polymeric material precursor, which contains activated carbon and/or at least one of 1-dimensional, 2-dimensional, and 3-dimensional nano/micro-materials in polystyrene and/or thermoplastic polymer and/or polymer blend matrix to carry a co-blowing agent such as water without using any surfactant-like molecules and/or polymers, having or adapted to have the properties of low density, high-R value, good mechanical properties, and fire retardance thereof. Exemplary embodiments of the present invention include various manufacturing methods, which are not limited to extrusion, batch molding, and injection molding. One example includes synthesis and CO₂ and water-based extruded foaming of such a material.

In addition to the novel features and advantages mentioned above, other benefits will be readily apparent from the following descriptions of the drawings and exemplary embodiments.

### BRIEF DESCRIPTION OF THE FIGURES

FIG. 1 shows several SEM micrographs of extrusion foams for comparative purposes: Forming conditions: CO₂ as the blowing agent (200° C., CO₂ pressure=890 Psi; CO₂ flow rate=3 g/min; die pressure=1200 Psi; screw rotation speed=50 rpm; feeding rate=50 rpm)−from left to right: (a) PS foam (no water); (b) PS/1% AC/0.01% water; (c) PS/1% AC/0.08% water; (d) PS/1% AC/0.36% water; and (e) PS/1% AC/0.54% water.

FIG. 2 is a graph of cell size distribution of examples of PS and PS/AC foams blown by CO₂ and water, in accordance with one embodiment of the present invention.

FIG. 3 shows a single SEM micrograph of extrusion foam in accordance with one embodiment of the present invention.

FIGS. 4(a) through 4(d) show examples of the moisture evaporation rate of PS and AC samples wet by different methods.

FIGS. 5(a) and 5(b) show examples of SEM micrographs of foam morphology of PS/0.5% talc foams: FIG. 5(a) with CO₂, and FIG. 5(b) with HCFCs. The scale bar is 1 mm.

FIG. 6 shows an example of extruded foam morphology and cell size distribution of PS/5% AC/0.5% water hand mix. The scale bar is 500 um.

FIGS. 7(a) and 7(b) show examples of extruded foam morphology and cell size distribution of foams: FIG. 7(a) PS/3.0% AC, and FIG. 7(b) PS/3.0AC/0.5% water composite foam. The scale bar is 200 um.

FIGS. 8(a) through 8(c) show examples of extruded foam morphology and cell size distribution of foams: FIG. 8(a) PS/5% AC, FIG. 8(b) PS/5% AC/0.5% water, and FIG. 8(c) PS/5% AC/1.5% water composite foam. The scale bar is 200 um.

FIG. 9 shows examples of sample pictures after IR absorption with different exposed times. Left to right: PS/0.5% talc, PS/3% AC/0.5% water, and PS/5% AC/0.5% water.

FIG. 10 shows examples of the thermal conductivity of different foams.

FIG. 11 shows examples of thermal conductivities of foams before and after one month of aging.

### DETAILED DESCRIPTION OF THE EXEMPLARY EMBODIMENTS

One exemplary embodiment of the present invention relates to the synthesis of nanocomposites using particulate-like, plate-like and fiber-like nanoparticles with high CO₂ and water affinity. Polymers and/or polymer blends including a minor phase with high CO₂ or water solubility may be used as the matrix material. These polymer nanocomposites may then be used to produce high-performance foam products aimed at both insulation and structural applications. The presence of nanoparticles and polymer blends may allow for better control of cell morphology and foam density in the manufacturing processes. For example, the low density (p<0.04 g/cm³) foams with better thermal insulation, fire resistance, and mechanical strength may be for thermal insulation applications, while the high-density (p>0.5 g/cm³) nanocomposite foams and sandwich foams with a similar mechanical strength as solid polymers may be for structural insulation applications. Successful implementation of this novel technology can lead to significant energy savings, material savings, and enhanced environmental protection, all of which are critical to the economy and societal health.

Some exemplary embodiments of the present invention relate to synthesis and CO₂ and/or water-based extrusion, batch and injection molding of polystyrene and/or thermoplastic polymer or polymer blend composites, which contains activated carbon and/or at least one of 1-dimensional, 2-dimensional and 3-dimensional nano/micro-materials in polystyrene and/or thermoplastic polymer and/or polymer blend matrix to carry a co-blowing agent such as water (which may be used alone as the blowing agent) without using any surfactant-like molecules and/or polymers, having the properties with low density, high-R value, good mechanical properties and fire retardance thereof.

As used herein, “surfactant-like molecules and/or polymers” refers to molecules and/or polymers that are used to mediate the admixture or dissolution of water into base polymers such as those used in accordance with the present invention. Some commonly encountered surfactants of each type include: ionic surfactants including, but not limited to, anionic surfactants (typically based on sulfate, sulfonate, or carboxylate anions), bis(2-ethylhexyl) sulfosuccinate, sodium salt, sodium dodecyl sulfate (SDS), ammonium lauryl sulfate, and other alkyl sulfate salts, sodium laureth sulfate, also known as sodium lauryl ether sulfate (SLES), alkyl benzene sulfonate, soaps, and fatty acid salts; cationic surfactants (typically based on quaternary ammonium cations) including, but not limited to, cetyl trimethylammonium bromide (CTAB), a.k.a. hexadecyl trimethyl ammonium bromide, and other alkyltrimethylammonium salts, cetylpyridinium chloride (CPC), polyethoxylated tallow amine (POEA), benzalkonium chloride (BAC), benzethonium chloride (BZT), zwitterionic (amphoteric), dodecyl betaine, dodecyl dimethylamine oxide, cocamidopropyl betaine, and coco ampho glycinate; and nonionic surfactants including, but not limited to, alkyl poly(ethylene oxide), copolymers of poly(ethylene oxide), poly(propylene oxide) (commercially called Poloxamers or Poloxamines), and alkyl polyglucosides, including, but not limited to: octyl glucoside, decyl maltoside, fatty alcohols, cetyl alcohol, oleyl alcohol, cocamide MEA, and cocamide DEA.

Typical values for high R-value are at a level of at least R=5.4 per inch thickness for extruded polystyrene foam. For low density, the presence of activated carbon may lead to higher water content in the pellets or beads and may reduce the water loss during storage and extrusion or injection molding. The presence of water cavities may significantly enlarge the cell size and leads to a foam product with ultra-low density (˜0.03 g/cc) and low thermal conductivity.

Polymeric foams are widely used in certain applications such as insulation, cushions, absorbents, and scaffolds for cell attachment and growth. Polystyrene (PS) foam ranks second among different foam materials. Extrusion and batch foaming processes are the two major techniques to produce PS foams. For extrusion foaming, hydrogen-containing chlorofluorocarbons (HCFC) and fluorocarbons (HFC) are currently used as blowing agents in the foam industry. In an exemplary embodiment of the present invention, supercritical CO₂ is an alternative choice because of its low cost, non-toxic and non-flammable properties, and relatively high solubility in many polymers.

In a typical batch foaming process, expandable PS (EPS) is generally prepared by the modified styrene suspension polymerization method. In general, an organic blowing agent such as pentane is used during polymerization. When heating the pentane-containing PS beads up to their glass transition temperature, PS foams are obtained. The flammable blowing agents, e.g., pentane, hexane, etc., however, are not suitable for the continuous foaming process due to safety reasons. Thus, the concept of water expandable polystyrene (WEPS) was proposed. Crevecoeur et al. [1] reported a two-step synthesis method, i.e., inverse emulsion and water suspension, to entrap water in the PS matrix. Pallay et al. [2] used starch as a water absorbent to replace the emulsifier in the inverse emulsion. After suspension polymerization, water was directly absorbed into the starch inclusions. This method requires surfactants to stabilize water, which is unfavorable for fire resistance application.

Until now, it is difficult to produce ultra-low density foams by extrusion using only CO₂ as the blowing agent because of the low solubility and high diffusivity of CO₂ in PS. Thus, it is necessary to introduce a co-blowing agent such as water in the CO₂ foaming process. Although previous studies have demonstrated that it is possible to obtain PS foams with ultra-low density (˜0.03 g/cc) for WEPS and water expandable polystyrene-clay nanocomposites (WEPSCN), the known work was mainly based on the batch foaming process and surfactants were also needed to trap water as a co-blowing agent.

In an exemplary embodiment of the present invention, an extrusion and injection molding foaming process involves using a physical phenomenon to directly entrap a co-blowing agent such as water into polystyrene-activated carbon nanocomposites. Other thermoplastic polymers and polymer blends may also be used.

For the thermal insulation application, the thermal insulation efficiency is dependent on the average cell size of the foams, the kinds of the polymers, and the blowing agent used. It is known that the extruded polystyrene foam blown by CFC has a higher thermal insulation value than that blown by CO₂ resulting from the low thermal conductivity of CFC. The foams containing infrared attenuating agents also could enhance the thermal insulation value. However, such addition of infrared attenuating agent will reduce the cell size and increase the bulk density.

One exemplary embodiment of the present invention produces PS nanocomposite foams with a lower bulk density and better infrared (IR) absorption than conventional PS/Talc foams under the same extrusion conditions without using any surfactant. These attributes will enhance thermal insulation efficiency. Other thermoplastic polymers and polymer blends can also be used.

To achieve this goal in one exemplary embodiment, water is introduced as a co-blowing agent with CO₂ to control the bulk density, bubble size, and expansion ratio in the extrusion and injection molding processes. PS and most thermoplastic polymers and polymer blends are hydrophobic, and will not absorb any water. Thus, a carrier may be used to carry water into the extruder. This carrier preferably does not reduce the bubble size or increase the bulk density of the foam. It is known that activated carbon (AC) is a good absorbent for liquids and gases with high thermal stability. Therefore, one exemplary embodiment of the present invention features the use of activated carbon as a liquid (e.g., water) carrier. The results described below elucidate its effect in exemplary PS foaming processes.

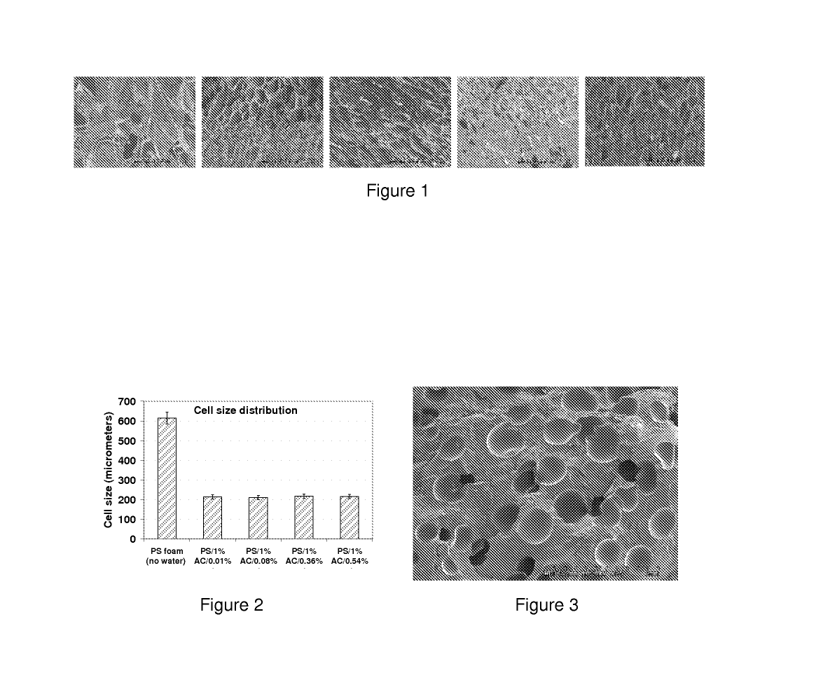

Preliminary test results showed that there are no significant differences in the properties of sample PS/AC foams blown by CO₂ with/without the presence of water (FIG. 1).

It was also observed that the average bubble sizes of PS/AC foams are 3 times smaller than that of PS foams (FIG. 2). Activated carbon has a higher CO₂ affinity than pure PS and more nucleation centers are generated by activated carbon in the PS matrix. Although not limited to the theory upon which the invention operates, it is believed that this may explain why the cell size decreases when activated carbon is present in the foaming process. The cell size, however, is similar to that of the PS/TiO₂ foams and much larger than that of PS/nanoclay foams. For thermal insulation foams, this is a positive result. However, the water absorbed by AC did not show any significant effect on the cell size in the extrusion process (FIG. 2). Again, though theory does not limit the present invention, it is believed that the water evaporated in the first zone of the extruder and then escaped from the feeding hopper due to the high operation temperature, ˜200° C., in the extruder.

PS/AC/water samples from different zones in the extruder were examined, and it was found that the water content was very low in the extracted samples. For example, when 1.33% w/w of water in PS with 1.0% AC was loaded into the extruder, the sample extracted from the middle zone showed only 0.012% w/w of water remaining in the PS/0.03% AC. Most of the water (˜70% by wt) evaporated due to the high temperature but some voids resulting from the 30% wt of remaining water could be observed in the extracted samples (FIG. 3).

Such void in microsize (FIG. 3) generated by water entrapped in the PS/AC matrix becomes an excellent reservoir for liquids such as water, ethanol, hexane, etc. These liquids may act as a co-blowing agent to assist PS composite foaming. This novel water encapsulation technique is intended to overcome the problem arising from water evaporation in the extrusion process.

The liquid media may diffuse into the pores of the activated carbon and the voids of PS/AC composite when the PS/AC composite is mixed or suspended in the liquids under Tg (soften temperature) and high pressure. The liquids include the chemical agents that evaporate, decompose, or react under the influence of heat to form a gas, ranging from hydrocarbon (e.g., butane, pentane, hexane, cyclohexane, petroleum ether, natural gases, etc.), halogenated hydrocarbon (e.g., methylene chloride, dioctyl phthalate, etc.), alcohol (e.g., methanol, ethanol, isoproponal, etc.), dihydric alcohol, polyhydric alcohol, ketone, ester, ether, amide, acid, aldehyde, water, or a mixture thereof.

In placing the liquid blowing agent into the base polymer, one typically maintains the liquid blowing agent under pressure (typically above atmospheric to about 400 psi, preferably 100 psi) and at either room temperature or an elevated temperature below or above Tg of the base polymer (typically more than 20 degrees above Tg). These conditions are maintained for a period of time sufficient to entrain the liquid blowing agent into the foaming facilitating material. This period of time may vary depending upon the diffusion rate in each case, but typically will be on the order of minutes up to several hours (e.g., 12 hours at Tg+20). The pellets, upon cooling to room temperature and return to atmospheric pressure, can be further handled for extrusion processing, batch forming processing, or injection molding.

An exemplary embodiment of the process of the present invention may be carried out with any primary blowing agent, such as CO₂ or N₂ or hydrofluorocarbon or fluorocarbon or mixtures thereof. Fluorocarbon and hydrofluorocarbon may include such substances as CFC11, HCFC 123 or HCFC 141b.

The blowing agent(s) may also be any liquids that evaporate, decompose, or react under the influence of heat to form a gas, and activated carbon may be used as a carrier to carry these blowing liquids into foamable polymers. Water is a preferred liquid of one exemplary embodiment of the present invention. These liquids include the chemical agents that evaporate, decompose, or react under the influence of heat to form a gas, ranging from hydrocarbon (e.g., butane, pentane, hexane, cyclohexane, petroleum ether, natural gases, etc.), halogenated hydrocarbon (e.g., methylene chloride, dioctyl phthalate, etc.), alcohol (e.g., methanol, ethanol, isoproponal, etc.), dihydric alcohol, polyhydric alcohol, ketone, ester, ether, amide, acid, aldehydes, water, or a mixture thereof.

High-pressure reaction chambers at the controlled temperature, 100˜130° C., were used to conduct experiments involving the methods and compositions of the present invention. The preliminary results were very promising. Water is entrapped into the polymer composite matrix and can survive in the extrusion and batch foaming processing.

One example of the methods and compositions of the present invention may use any polystyrene composite which contains activated carbon and/or at least one of 1-dimensional (e.g, smectite clays (organoclays) or nanographites (graphite, graphene, and graphene oxide)), 2-dimensional (e.g., carbon nanofibers, multiwall carbon nanotubes, single wall carbon nanotubes, conducting polymer nanofibers/nanotubes, polymer nanofibers/nanotubes, etc.), and 3-dimensional (e.g, quantum dots, polyoctahedralsilasesquioxanes (FOSS), silica, TiO₂, ZnO or Fe₃O4 nanoparticles, etc.), nano/micro-materials in polystyrene matrix to carry water without using any surfactant-like molecules and/or polymers, having the properties with low density, high-R value, bimodal structures, good mechanical properties and fire retardance thereof.

The polymers used in accordance with the present invention typically are such that the macromolecules include polystyrene/PMMA blend, polystyrene/PPO blend, thermoplastic polyolefin (TPO), polystyrene/high-impact polystyrene (HIPS) blend, PMMA, HIPS, polyvinylchloride (PVA), maleic anhydride modified PP (poly propyl methacrylate (PPMA), polyethylene vinyl acetate (PEVA), acrylonitrile butadiene styrene (ABS), acrylic celluloid, cellulose acetate, ethylene-vinyl acetate (EVA), ethylene vinyl alcohol (EVAL), fluoroplastics (e.g., PTFE, FEP, PFA, CTFE, ECTFE, and ETFE), ionomers, Kydex (a trademarked acrylic/PVC alloy), liquid crystal polymer (LCP), polyacetal (e.g., POM and acetal), polyacrylates (acrylic), polyacrylonitrile (e.g., PAN and acrylonitrile), polyamide (e.g., PA and nylon), polyamide-imide (PAI), polyaryletherketone (PAEK or ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), polysulfone, polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC), Spectralon (a commercially available resin), or a mixture of any of the foregoing.

An example of the method of the present invention may be carried out through the following preferred steps.

Step (1) Prefoaming stage: Compounding and pelletizing activated carbon (or other suitable material as described herein) with thermoplastic polymers with a certain concentration (preferred range of 0.01-20% by weight); the 1D, 2D and/or 3D nanoparticles may be added in this step with a certain ratio to activated carbon ranging from 0.01 to 2,000%.

Step (2) Blowing liquids trapping stage: The prefoamed activated carbon/thermoplastic polymer pellets with a ratio of 0-2000 wt % nanoparticles to activated carbon are soaked in the blowing liquids and then are pressured at or above atmosphere pressure (14.7 psi-2000 psi), preferred 100 psi, under room temperature or a temperature below or above Tg (e.g., Tg+20˜30 degree) for a certain period until the diffusion of the said liquids into the said polymer matrix achieves a desirable level, e.g., 12 hours.

Step(3) Foaming stage: The as-prepared, liquids-containing activated carbon/thermoplastic polymers with/without nanoparticles composites pellets obtained from step (2) are subjected to extrusion foaming, batch foaming, or injection molding foaming processes to form the desired foams with or without the blowing gases; preferred with CO2, N2, Argon, CFC, HCFC, etc.

### Extrusion, Batch and Injection Molding Foamed Polymer Method—Water and Blowing Agent

Generally, an example of the method of the present invention may be summarized as a method of making a foamed polymer comprising: (a) preparing a foamable polymeric material precursor comprising: (1) a polymeric material selected from the group consisting of polystyrene, thermoplastic polymers, and polymer blends thereof; (2) a foaming facilitating material having liquid (e.g., water) affinity and selected additional material selected from the group consisting of activated carbon, charcoal (especially bamboo charcoal), 1-dimensional, 2-dimensional, and 3-dimensional nano/micro-materials and mixtures of two or more thereof, the foaming facilitating material adapted to contain liquid (e.g., water) in the absence of any surfactant-like molecules or polymers; (3) a blowing agent; and (4) liquid (e.g., water); and (b) preparing a foamed polymer from the foamable polymeric material precursor.

One may use known processing techniques for formulating and extruding, batch foaming or injection molding the foamable polymeric material precursor.

In an exemplary embodiment, it is preferred that the polymeric material is polystyrene, but it may include any thermoplastic materials such as those set forth herein.

In an exemplary embodiment, it may also be preferred that the polymeric material is polystyrene and that the foaming facilitating material comprises activated carbon.

In one exemplary embodiment, preferred amounts of the foaming facilitating material and the polymeric material are in relative amounts in a weight ratio in the range of from about 20% to about 0.01%.

The 1-dimensional, 2-dimensional, and 3-dimensional nano/micro-material may be selected from any material capable of containing small amounts of liquid (e.g., water), such as those as those set forth herein.

In one exemplary embodiment of the present invention, bamboo charcoal is another excellent liquid (e.g., water) affinity material that may be used together with or in place of the activated carbon. Similar to activated carbon, bamboo charcoal is a highly porous carbon based material with very high ability to absorb liquid (e.g., water) or the other blowing agents, including liquid and gas forms. In an exemplary embodiment of the present invention, bamboo charcoal may be compounded and pelletized with thermoplastic polymers preferably at from about 0.01 to about 20 wt %, and then soaked in liquid blowing agents, e.g., water, for a certain period (e.g., 12 hours), at a suitable temperature (e.g., Tg+20-30° C.) under a suitable pressure (e.g., 100 psi). Under such operation, the liquid blowing agents may be trapped into the bamboo charcoal thermoplastics composites.

In an exemplary embodiment, an additional blowing agent besides liquid (e.g., water) is provided (as the method may be carried out with water alone), the blowing agent may be any agent effective to provide a foaming action, such as those set forth herein. Preferably, the blowing agent comprises CO₂. It is also possible that an exemplary method of the present invention may be carried out with a blowing agent alone.

One preferred method is carried out such that the foamable polymeric material precursor consists essentially of constituents (1)-(4) as set forth above.

Exemplary embodiments of the present invention include products made in accordance with any of the variations of the method disclosed herein.

### Extrusion, Batch and Injection Molding Foamed Polymer Method—Liquid Blowing Agent, e.g., Water Only

An exemplary embodiment of the present invention also includes a method of making an extrusion, batch or injection molding foamed polymer compising: (a) preparing a foamable polymeric material precursor comprising: (1) a polymeric material selected from the group consisting of polystyrene, thermoplastic polymers, and polymer blends thereof; (2) a foaming facilitating material having liquid (e.g., water) affinity and selected additional material selected from the group consisting of activated carbon, charcoal (especially bamboo charcoal), 1-dimensional, 2-dimensional and 3-dimensional nano/micro-materials and mixtures of two or more thereof, said foaming facilitating material adapted to contain liquid (e.g., water) in the absence of any surfactant-like molecules or polymers; and (3) a liquid blowing agent; and (b) preparing a foamed polymer from the foamable polymeric material precursor.

The liquid blowing agent may be selected from the group consisting of hydrocarbons, halogenated hydrocarbons, alcohols, dihydric alcohols, polyhydric alcohols, ketones, esters, ethers, amides, acids, aldehydes, such as the examples described herein, water or mixtures thereof.

### Extrusion, Batch and Injection Molding Foamed Polymer

An exemplary embodiment of the present invention also includes a foamed polymeric material comprising: (a) a polymeric material selected from the group consisting of polystyrene, thermoplastic polymers, and polymer blends thereof; and (b) a foaming facilitating material having water affinity and selected additional material selected from the group consisting of activated carbon, 1-dimensional, 2-dimensional, and 3-dimensional nano/micro-materials and mixtures of two or more thereof, said foaming facilitating material adapted to contain liquid (e.g., water) in the absence of any surfactant-like molecules or polymers; and wherein said foamed polymeric material is substantially free of any surfactant-like molecules or polymers.

The constituents of the polymeric material and foaming facilitating material may be as set forth herein.

It may be preferred in one exemplary embodiment that the foamable polymeric material precursor consists essentially of (a) and (b), and that the cells contain CO₂.

For conventional thermal insulation materials, the foamed polymer typically will have cells of an average cell size less than 200 micrometers, preferably less than 100 micrometers.

For structural materials, the foamed polymer typically will have cells of an average size in the range of from about 1 to about 10 micrometers for microcellular foams, and at or less than 0.10 micrometers for nanocellular foams.

### Extrusion, Batch and Injection Molding Foamed Polymer Precursor Preparation Method—Liquid Blowing Agent, e.g., Water Only

An exemplary embodiment of the present invention also includes a method of preparing a foamable polymeric material precursor comprising generally: (a) obtaining a solid polymeric composite comprising: (1) a polymeric material selected from the group consisting of polystyrene, thermoplastic polymers, and polymer blends thereof; and (2) a foaming facilitating material having liquid (e.g., water) affinity and selected additional material selected from the group consisting of activated carbon, 1-dimensional, 2-dimensional and 3-dimensional nano/micro-materials and mixtures of two or more thereof, the foaming facilitating material adapted to contain liquid (e.g., water) in the absence of any surfactant-like molecules or polymers; and (b) exposing a solid polymeric composite to a liquid blowing agent(s) at a temperature below or above the softening temperature of the solid polymeric composite and at a pressure at or above atmospheric pressure for sufficient time to introduce the liquid blowing agent(s) into the foaming facilitating material.

An exemplary embodiment of the present invention may thus produce CO₂ and/or water-containing polymer nanocomposite foams with both mechanical and thermal insulation properties superior to foams produced with either hydrochlorofluorocarbon (HCFC) or hydrofluorocarbon (HFC) blowing agents.

The replacement of the ozone-depleting substances in an exemplary embodiment of the present invention allows one to retain the insulating R-value and decrease manufacturing costs. The replacement in an exemplary embodiment of the present invention may maintain the insulating R-value and decrease manufacturing costs.

Exemplary embodiments of the present invention may provide light-weight and low-cost microcellular, nanocomposite materials with tunable thermal and mechanical properties. These nanocomposite foams may save not only raw materials derived from petrochemicals but also energy consumption through the product's lifetime.

The technical approach for surmounting the challenges associated with the use of nanomaterials and CO₂ as a blowing agent is described below.

Nanoparticle Material Innovations: Polymer nanocomposites have demonstrated impressive improvements in mechanical strength without losing toughness/impact strength. A recent study by NIST and several research groups showed that adding nanoclay to polymers can address fire prevention issues.

Recent work has shown that the different distribution morphology of nano-montmorillonite (MMT) clay particles in polystyrene rigid foams (clay layers become exfoliated, intercalated, or agglomerated) greatly changes the cell density, cell size and orientation, and other cell morphology characteristics.

However, it has also been found that the modifiers currently used in preparing the commercial nanoclay precursor present a fire hazard.

The nanoclay/polystyrene composite foams suffer from a very high ignitability (low oxygen index) due to the presence of a high amount of organic surface modifiers. To achieve truly fire resistant advantages, exemplary embodiments of the present invention may provide for fire retardant modifiers, low modifier content nanoparticles, or a special treatment to eliminate the modifier during compounding.

Exemplary embodiments of the present invention may provide for the development of multi-functional nano-carbon materials including layered graphite, nanoporous activated carbon, carbon nanofibers (CNF) and multi-wall carbon nanotubes (MWCNT), which may not only work as a cell morphology control agent and a gas diffusing barrier, but also an infrared attenuation agent and a carrier for benign co-blowing agents such as water to enhance the insulation R-value.

Blowing Agent Innovations: The use of traditional chlorofluoromethane blowing agents has been prohibited globally because of the high ozone depletion effect. Among the potential replacements, CO₂ is the most favorable, because it is non-toxic, environmentally benign (zero Ozone Depletion Potential, and 100 year Globe Warming Potential only one in comparison with 1300 for HFC-134a, and 2000 for HCFC-142b), and it is inexpensive.

Companies such as Dow Chemical and Owens Corning are very active in research and development related to the use of CO₂ as a future blowing agent.

For example, Dow has been granted patents (U.S. Pat. Nos. 5,250,577, 5,266,605 and 5,389,694, hereby incorporated herein by reference) for CO₂-containing polystyrene foams and Owens Corning has been granted patents (WO 00/15701 and U.S. Pat. No. 6,268,046, hereby incorporated herein by reference) for a process for producing extruded polystyrene with CO₂ as a blowing agent. However, the CO₂-containing foam products developed to date are intended primarily for use in the packaging market, for which thermal insulation properties and structural strength are not as critical as in the building insulation market.

Thus, exemplary embodiments of the present invention may provide a method of producing CO₂ and/or water-containing polymer foam that has both tunable thermal insulation property and mechanical strength in comparison with existing polymer foam board.

The primary three issues regarding CO₂ that may be addressed by exemplary embodiments of the present invention thus are: (1) the low solubility of CO₂ in polymer melts. For instance, the solubility of CO₂ in polystyrene is only about 3.5% at elevated temperature and pressure, at 150° C. and 10 Mpa. However, a solubility of about 5 to 6% is required to achieve the necessary cell growth; and (2) CO₂ has a high diffusivity in the polymer melt due to its small size. While this ensures a fast mixing process, it also offers a quick escape from the foam after processing. Compared with HCFC's, CO₂ has a much greater nucleation ability, which means that nuclei can be created without the aid of nucleation agents; and (3) higher gas thermal conductivity in comparison with that of HFC blowing agents. The challenges of developing CO₂ as a foaming agent arise therefore from solubility limitations, high-pressure operation, high thermal conductivity, and rapid gas escape after the foaming process.

Exemplary embodiments of the present invention may provide several alternatives, such as: (1) modifying the structure or composition of the polymer and polymer blends to increase intermolecular interactions with CO₂ or water or other suitable materials as described herein; and (2) adding nanoparticles that have a high affinity for CO₂ or water, for example.

In the known art, the surfactant introduced onto the particle surface to achieve good compatibility between the inorganic nanoparticles and the organic polymer or monomer to achieve good particle dispersion is usually a flammable material.

Using activated carbon to carry nanoclay-water into the polymer matrix may therefore achieve surfactant-free composites with good clay dispersion. Incorporation of a very small amount of nanoclay (typically no more than 0.5% by weight) may substantially increase the expansion ratio of PS composites.

Using CO₂ as the co-blowing agent, for example, the resultant PS foams exhibited lower bulk density and a cell structure better than the current insulation foams. Together with the lower bulk density, the activated carbon PS foam is superior to the PS or WEPS foams for thermal insulation applications. CO₂-assisted extrusion foaming of water-containing activated carbon-PS foam beads can reach a bulk density of 0.032 g/cc with a thermal conductivity of 20 mW/mK.

Materials produced in accordance with exemplary embodiments of the present invention may therefore eliminate the need of an expensive vacuum system, and one can realize the complete replacement of HCFC and HFC by CO₂ if desired.

Examples of foamable mixtures of the present invention may be extruded and foamed into foam products, such as foam board, foam sheet and other foam structures, which are also part of the present invention.

### Example 1

Activated carbon (AC) and polystyrene (PS) pellets were compounding in preferred concentration, e.g., the weight ratio of AC/PS ranged from 20% to 0.01%, and pelletized via extruder. The AC/PS pellets were suspended in water and then transferred into autoclave at temperature ˜120° C. for 2 min to 12 hours. As-prepared samples contained 0.5 to ˜13% of water for 3% of AC/PS composite. The amount of absorbed water in AC/PS can be adjusted to the certain concentration using a convection oven at ˜40° C. to remove water.

### Example 2

47 g of PS pellets were dissolved in 53 g of styrene, 0.25 g of AIBN, 0.15 g of BPO and 3 g of activated carbon. The mixture was kept overnight at room temperature until all PS pellets were dissolved. 200 ml of water was added into the viscous solution (around 100 g) and then the mixture was transferred to an autoclave and then polymerized at 120° C. under 100 psi for 2 min to 12 hours to achieve complete reaction. Finally, the suspension was cooled to room temperature. The black product was crushed into small fragments (˜5 mm) and stored in water. Water on the surface of PS/AC beads was removed before foaming.

### Example 3

47 g of PS pellets were dissolved in 53 g of styrene, 0.25 g of AIBN, 0.15 g of BPO and 3 g of activated carbon. The mixture was kept overnight at room temperature until all PS pellets were dissolved. The mixture was polymerized at 120° C. under a high stirring rate (800 rpm) for 12 hours at atmosphere. The black product was suspended in 200 ml of water and then transferred to an autoclave and post-cured at 120° C. under 100 psi for 2 min to 12 hours. The black product was crushed into small fragments (˜5 mm) and stored in water. Water on the surface of PS/AC beads was removed before foaming.

### Example 4

To 97 g of styrene, 3 g of activated carbon, was 0.25 g of AIBN and 0.25 g of BPO, 200 ml of water was added. The suspension mixture was transferred to an autoclave and then polymerized at 120° C. under 100 psi of pressure for 2 min to 12 hours to achieve complete reaction. Finally, the suspension was cooled to room temperature. The black product was crushed into small fragments (˜5 mm) and stored in water. Water on the surface of PS/AC beads was removed before foaming.

### Example 5

97 g of styrene, 3 g of activated carbon, with 0.25 g of AIBN (initiator) and 0.25 g of BPO was polymerized at 120° C. at a high stirring rate (800 rpm) for 2 min to 12 hours. The black product was suspended in 200 ml of water and then transferred to an autoclave and post-cured at 120° C. under 100 psi for 12 hours. The black product was crushed into small fragments (˜5 mm) and stored in water. Water on the surface of PS/AC beads was removed before foaming.

### Example 6

Activated carbon (AC) and thermoplastic polymer pellets were compounded in preferred concentration, e.g., the weight ratio of AC/thermoplastic polymers ranged from 20% to 0.01%, and pelletized via extruder. The AC/thermoplastic polymer pellets were suspended in water and then transferred into autoclave at Tg+20° C. of each thermoplastic polymer for 2 min to 12 hours. As-prepared samples contained 0.5 to ˜13% of water for 3% of AC/thermoplastic polymer composite. The amount of absorbed water in AC/thermoplastic polymer can be adjusted to the certain concentration using convention oven at ˜40° C. to remove water. The thermoplastic polymers may include polystyrene/PMMA blend, polystyrene/PPO blend, thermoplastic polyolefin (TPO), polystyrene/high-impact polystyrene (HIPS) blend, PMMA, HIPS, polyvinylchloride (PVA), maleic anhydride modified PP (polypropyl methacrylate (PPMA)), polyethylene vinyl acetate (PEVA), acrylonitrile butadiene styrene (ABS), acrylic celluloid, cellulose acetate, ethylene-vinyl acetate (EVA), ethylene vinyl alcohol (EVAL), fluoroplastics (e.g., PTFE, FEP, PFA, CTFE, ECTFE, and ETFE), ionomers, Kydex (a trademarked acrylic/PVC alloy), liquid crystal polymer (LCP), polyacetal (e.g., POM and acetal), polyacrylates (acrylic), polyacrylonitrile (PAN or acrylonitrile), polyamide (e.g., PA and Nylon), polyamide-imide (PAI), polyaryletherketone (PAEK or ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), polysulfone, polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC), Spectralon (a commercially available resin), or a mixture thereof.

### Example 7

In example 6, the liquid used for co-blowing agent includes the chemical agents that evaporate, decompose, or react under the influence of heat to form a gas, ranging from hydrocarbon (e.g., butane, pentane, hexane, cyclohexane, petroleum ether, natural gases, etc.), halogenated hydrocarbon (e.g., methylene chloride, dioctyl phthalate, etc.), alcohol (e.g., methanol, ethanol, isoproponal, etc.), dihydric alcohol, polyhydric alcohol, ketone, ester, ether, amide, acid, aldehyde, water, or a mixture thereof.

### Example 8

In example 6, the primary blowing agent is CO₂ or N₂ or hydrofluorocarbon or fluorocarbon or mixtures thereof. Fluorocarbon and hydrofluorocarbon include CFC11, HCFC 123, or HCFC 141b, etc.

### Example 9

In example 6, the thermoplastic composite contains activated carbon and/or at least one of 1-dimensional (e.g., smectite clays (organoclays) or nanographites (graphite, graphene, and graphene oxide), 2-dimensional (e.g., carbon nanofibers, multi-wall carbon nanotubes, single wall carbon nanotubes, conducting polymer nanofibers/nanotubes, polymer nanofibers/nanotubes, etc.), and 3-dimensional (e.g, quantum dots, polyoctahedralsilasesquioxanes (FOSS), silica, TiO₂, ZnO or Fe₃O₄ nanoparticles, etc.), nano/micro-materials in polystyrene matrix to carry co-blowing agents as set forth in Example 7 without using any surfactant-like molecules and/or polymers, having the properties with low density, high-R value, bimodal structures, good mechanical properties and fire retardance thereof.

### Example 10

In examples 1-9, the foaming method can be extrusion foaming or batch foaming or injection molding foaming.

### Example 11

In this example, water was used as a co-blowing agent and contained in activated carbon in a carbon dioxide (CO₂) extrusion foaming process in a twin screw extruder. Using activated carbon and water in this manner, increased infrared absorption and decreased foam density resulted in better thermal insulation. Different strategies have been studied including direct injection of water into the extruder with surfactants, extrusion foaming of water expandable polystyrene (WEPS) beads, and feeding water containing activated carbon (WCAC)/polystyrene (PS) pellets. In comparing these strategies, it was found that WCAC/PS pellets provided the most stable and clean extrusion process, more uniform cell morphology, and better thermal insulation than other methods.

Polymeric foams are widely used in applications such as insulation, cushions, absorbents, and recently in biological applications, e.g., scaffolds for cell attachment and growth [4-6]. PS foam is the second most widely used material and has potential for additional growth in the future [7]. Two important techniques for producing thermal insulation PS foams are extrusion of foamed board and batch foaming of expandable PS (EPS) [8]. For the former process, hydrogen-containing chlorofluorocarbons (HCFCs) and fluorocarbons (HFCs) have been used as blowing agents in the foam industry. However, they have to be replaced soon due to ozone-depletion and global warming problems. Compared to hydrocarbons and other gases, CO₂ is a promising material to replace HCFCs and HFCs because it is nonflammable, inexpensive, environmentally benign, and has better solubility in polymers than other inert gases [9, 10].

However, CO₂ has the drawbacks of low solubility and high diffusivity in polymers compared to HCFCs/HFCs. This greatly impedes the development of using CO₂ as a foaming agent on an industrial scale.

In the application of thermal insulation foams, low density is a desired property. However, the low solubility and high diffusivity of CO₂ in polymers make it difficult to produce low density foams by extrusion using CO₂ as a blowing agent. A recent study [11] showed that adding water during the CO₂ foaming process can increase cell size and decrease form density.

Due to the hydrophobic nature of PS, it is difficult to disperse water directly in PS. In the known art, surfactants or absorbents have been added to promote water dispersion. In one method [12-14], water was emulsified in a pre-polymerized styrene/PS mixture in the presence of emulsifiers. Subsequently, the inverse emulsion was suspended in a water medium containing suspension agents. Polymerization was continued until complete conversion. The final products were spherical PS beads with entrapped micrometer-scaled water droplets, WEPS. In another known method [15], water and surfactants were injected into the extruder to make WEPS pellets. Instead of using emulsifiers or surfactants, starch was also used as a water-swellable phase [16-19]. Pre-polymerization of the styrene/starch mixture was carried out to a lower conversion. The viscous reaction phase was subsequently transferred to a water medium containing suspension agents. Finally, polymerization was completed and water was directly absorbed into the starch inclusions. In a previous study [20] by the inventors, nanoclay was used as an absorbent in the suspension polymerization process. The water content of water expandable polystyrene-clay nanocomposites (WEPSCN) is substantially higher than that of WEPS and thus can reduce the loading level of surfactants.

Activated carbon (AC) has an exceptionally high surface area which makes it an excellent water-absorbent. In an early study [21], the inventors investigated the effect of water content in the extrusion foaming process by feeding AC particles containing varying amounts of water together with PS. However, most of the water was evaporated by the heat generated from the extruder and only a slight decrease in bulk density was observed [20]. In another study [11], the inventors pre-saturated AC particles with water before introducing them into the styrene/PS solution. The viscous mixture was subsequently transferred to a water medium containing suspension agents. Via the suspension polymerization, PS beads loaded with water containing AC particles were produced. By applying these beads into the extrusion foaming process with CO₂ as a blowing agent, the early water evaporation problem was eliminated. Infrared (IR) transmission showed that foams containing AC absorbed more IR than that without AC. However, excess amounts of water (more than 12%) inside and outside the beads resulted in steam formation during extrusion and created undesirable water overflow from the screw shafts.

In this example, the inventors describe a new method by compressing water into pre-compounded PS/AC pellets under elevated temperature and pressure. The pellets were then fed in the CO₂ extrusion foaming process. This example of the method eliminates the expensive suspension polymerization process and the use of any surfactants. For comparison, PS foams were made by direct injection of water/surfactant and CO₂ into the extruder. AC particles pre-soaked with water and then hand mixed with PS before feeding into the extruder were also tried to make PS/AC foams. The extruded foam samples were characterized for morphology, thermal conductivity, and IR transmission measurements.

Nova 1600 PS with a MFI of 5.50 g/min was used in this example. Foaming agent CO₂ (>99.9%) was provided by Praxair. Coconut shell based AC particles, Sabre series CR1250CP, with an average diameter of 7 μm were provided by Carbon Resources, CA. The equilibrium moisture of AC was determined by ASTM D1412. The coconut based AC absorbs 60 wt % of moisture at 30° C. and 96-97% relative humidity. Talc, Cimpact 699, with a mean diameter of 1.5 um was supplied from Luzenac. The surfactant, bis(2-ethylhexyl) sulfosuccinate (AOT) was purchased from Fluka and used.

Three methods were applied to introduce water in the foaming process: (a) water with 10 wt % AOT and CO₂ were injected into the extruder simultaneously using two syringe pumps at different locations. CO₂ was injected from zone 4 while water was injected from zone 7 of a 9-zone twin screw extruder. (b) Water was pre-mixed with AC and then blended with PS in a bag by manual shaking. The mixture was then extrusion foamed with CO₂. (c) PS with AC was compounded using the twin screw extruder. The blending temperature varied between 165 and 170° C. and the extruder was running in the co-rotating mode at 150 rpm. The compounded PS/AC pellets were immersed in water and compressed with nitrogen at 120° C. and 0.69 MPa (100 psi) for 12 hours. Subsequently, the pellets were wiped with paper towels and dried in a hood to remove excess water for desirable water content before extrusion foaming. Fifteen grams of PS/AC pellets were collected before extrusion foaming to determine the water content of PS/AC pellets.

The rate of water evaporation in each sample was determined by thermogravimetric analysis (TGA Q50, TA Instruments). The samples were heated to 105° C. and purged with dry nitrogen. The goal of this experiment was to determine the water evaporation rate from the samples. This information was useful for understanding whether the injected water may serve as a blowing agent in the extrusion process.

Extrusion foaming was carried out by pumping the blowing agent (CO₂) into a twin screw extruder (Leistritz Micro-27; L/D=40; D=27 mm) using a gas/liquid injection port. The extruder was outfitted with a slit die, a shaping die, and rollers for foam uptake. During the extrusion foaming process, the screw speeds of the feeder and extruder were both kept at 50 rpm. The barrel temperature was in the range of 190˜120° C. The pressure of CO₂ was kept at 7.58˜8.27 MPa (1100˜1200 psi) which may inject 4% of CO₂ into the PS melt. The die temperature was kept at 120° C. and the die pressure was in the range of 8.62˜10 MPa (1250˜1450 psi) depending on sample type. To compare the effectiveness of different blowing agents, PS foams were extruded with the same extruder using hydrogenated chlorofluorocarbons (HCFCs, H142B/22) as a blowing agent. H142B/22 (CClF2CH3/CHClF2 60/40 blend) has a specific gravity of 1.16 g/cm³ at 21° C., a vapor pressure of 0.55 MPa (79.4 psi) at 21° C., and a boiling point of −28° C. The loading level of HCFCs was 10 wt % with the injection pressure around 4.14˜5.52 MPa (600˜800 psi), a typical condition used in the industrial foaming process. The opening of the slit die and shaping die were kept the same in all experiments. Samples were cut and removed before entering the rollers.

The specimens for characterization were prepared by cutting segments out of the extruded foams and then sanded to achieve a thickness of about 6.5 mm. During this process, the skin of the foam was removed. After sanding, compressed air was blown on the foam samples to remove residual powders. The morphology of the foam was observed by a scanning electron microscope (SEM, Phillips XL30). Samples were cryo-fractured in liquid nitrogen, and the fracture surface was sputter-coated with gold.

Infrared (IR) transmission of each sample was measured using an in-house IR transmission tester to provide a property relevant to thermal insulation applications. This test provided data at a localized point, so the test was performed at several locations on the specimens. The input power was 0.5 Watts for all samples measured. The distance between the optical fiber output of the laser diode and the power meter was about 5 cm.

Thermal conductivity was measured using a heat flow meter (FOX 200, Laser Comp). The test followed ASTM C518. Temperature differences of the top and bottom plate were set as 0˜40° C., 10˜50° C., 20˜60° C. and 30˜70° C., respectively. Since the thermal conductivity of foams changes with time, the thermal conductivity was measured as extruded and after one month of storage.

The water content of the PS/AC pellets after being compressed with water is listed in Table 1.

TABLE 1
Water content of PS-AC pellets after
high pressure water treatment

| | PS/3% | PS/5% |
|---|---|---|
| | AC | AC |
| Water | 0.5 wt % | 1.5 wt % |
| Content | | |

Less than 2 wt % of water was compressed in the PS/AC pellets. Pure PS pellets were also compressed with water and tested for moisture content as the baseline. The result showed no water absorption.

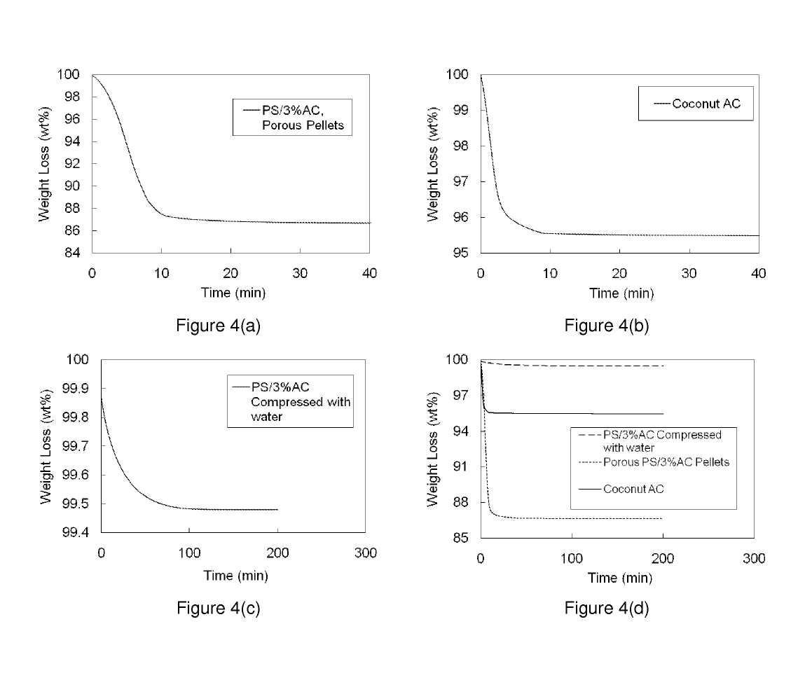

To investigate the evaporation rate of water, three different samples were tested by TGA: (1) coconut AC as received; (2) porous PS/3% AC pellets made by compounding non-dried AC with PS; and (3) extrusion compounded PS/3% dried AC compressed with water. In sample (2), pellets were collected upon compounding through the extrusion system equipped with a water cooling line. Since non-dried AC contains moisture, it resulted in porous pellets in the compounding process and a large amount of water was trapped in the pores. When AC was pre-dried, there were no pores in the compounded PS/AC pellets. Water was compressed into the porous AC under elevated temperature and pressure. The pellets in samples (2) and (3) were wiped by paper towel to remove surface water before testing. The results of weight loss versus drying time of different tests are shown in FIGS. 4(a), 4(b) and 4(c), while the comparison of these three curves is shown in FIG. 4(d). As shown in FIGS. 4(a) and 4(b), most water was evaporated within 10 minutes for porous PS pellets and AC. For the compounded PS/3% AC, water was trapped in AC and protected by the PS matrix. It took more than 100 minutes to remove moisture from this sample. Results from TGA experiments imply that it is difficult to evaporate moisture from PS/AC samples compressed with water, therefore, most of water inside the pellets may act as a blowing agent during the extrusion foaming process.

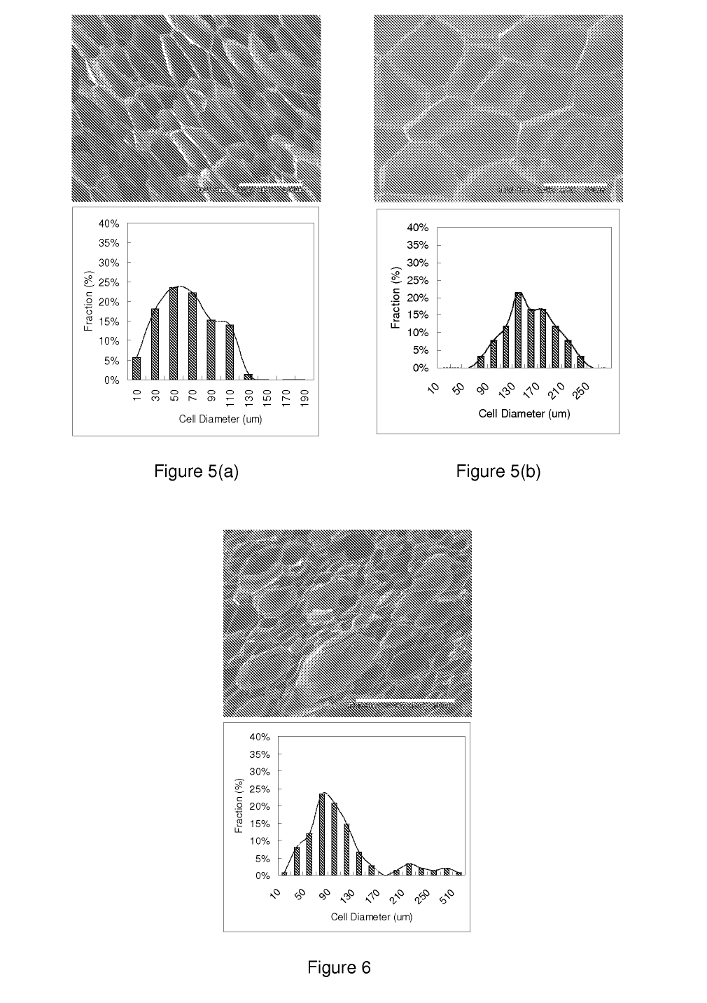

The SEM micrographs of PS/0.5% talc foams, a typical formulation for thermal insulation foams, made with CO₂ or HCFCs are shown in FIGS. 5(a) and 5(b), respectively, while their average cell size and cell density are listed in Table 2.

TABLE 2
Cell size and cell density of foams from different samples

| | Average | | |
|---|---|---|---|
| | Cell | Cell | |
| | Size | Density | Density |
| Sample | (um) | (cell/cm³) | (g/cm³) |
| PS/0.5% talc | 148.82 | 2.49 × 10⁴ | 0.036 |
| foamed with | | | |
| HCFCs | | | |
| PS/0.5% talc | 65.42 | 2.26 × 10⁵ | 0.046 |
| (CO₂) | | | |
| PS/3% AC (CO₂) | 56.87 | 3.41 × 10⁵ | N/A |
| PS/3% AC/0.5% | 72.56 | 1.89 × 10⁵ | 0.04 |
| water (CO₂) | | | |
| PS/5% AC (CO₂) | 40.74 | 9.57 × 10⁵ | 0.05 |
| PS/5% AC/0.5% | 60.22 | 4.89 × 10⁵ | 0.04 |
| water (CO₂) | | | |
| PS/5% AC/1.5% | 55.75 | 4.08 × 10⁵ | 0.035 |
| water (CO₂) | | | |
| PS/5% AC/0.5% | 99.56 | 2.6 × 10⁵ | 0.039 |
| water hand mix | | | |
| (CO₂) | | | |

SEM pictures are taken parallel to the extrusion direction. The cell size of samples foamed by HCFCs is more than twice the size, and the cell density is only one tenth of that foamed with CO₂. The bulk density of CO₂ foamed sample is 27% higher than that foamed with HCFCs because of higher diffusivity and lower solubility of CO₂. Previous studies [22] showed that the thermal conductivity of foams reaches a minimum at density ranging between 0.03˜0.07 g/cm³, therefore, a lower density may be preferred since it saves more materials. If a co-blowing agent such as water can result in larger cell size without decreasing the cell density in the CO₂ extrusion foaming process, the foam density can be lowered. In this regard, different methods were studied to introduce water in the CO₂ foaming process.

In the direct water injection method, water with 10 wt % AOT was injected into PS containing 0.5 wt % of talc as the nucleation agent. The loading level of water was controlled at 0.4˜0.6 wt % of PS. Since water was injected near the end of the screw, there might not be enough time for mixing. The die pressure was unstable and extrusion instabilities were observed. Steam shot out of the die and no sample could be collected. In the second method, AC was used as a water carrier. Water in the amount of 0.5 wt % was pre-mixed with 5 wt % AC and then blended with 95 wt % of PS in a bag by hand shaking. This sample was extrusion foamed and the result is shown in FIG. 6. A non-uniform cell size distribution was found and many large voids could be seen by naked eye. The results from these two methods imply that a better mixing or pre-compounding method is needed to introduce water into the extruder.

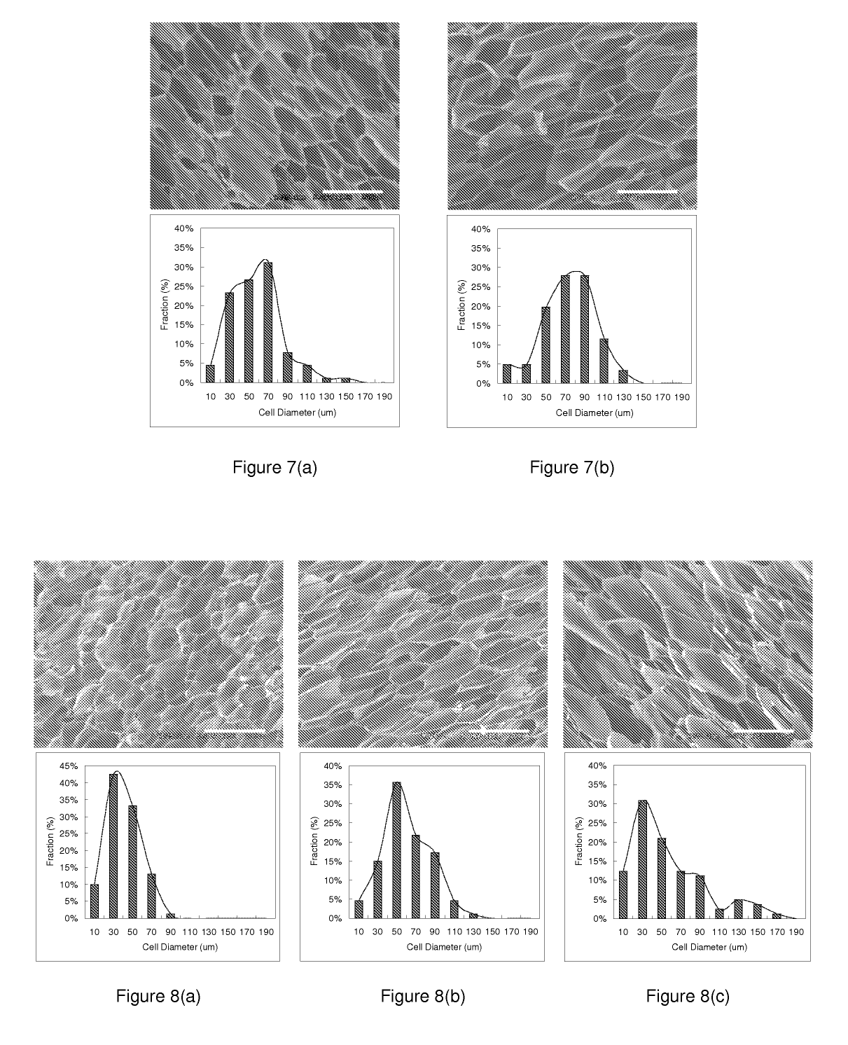

The PS/3% AC pellets compressed with 0.5% water were then extrusion foamed using the same extruder. PS foam made with the same pellets without water compression was also prepared for comparison. The SEM micrographs of PS/3% AC foams without and with water are shown in FIGS. 7(a) and 7(b), respectively. With the addition of 0.5 wt % water in the sample, the average cell diameter increased from 56.87 to 72.56 um. Our explanation is that the two blowing agents take effect at different times. The primary blowing agent of this exemplary embodiment (CO₂) would foam immediately when the die pressure dropped to a critical level. Water trapped in AC, on the other hand, would take longer time to foam. Consequently, the secondary blowing agent, water, may enlarge the size of cells foamed by the primary blowing agent, CO₂. A small amount of water affected not only the cell morphology but also the torque of the extruder. The torque was 82˜84% for dry PS/3% AC pellets, and it dropped to 74˜76% in the presence of 0.5 wt % of water.

To understand the effect of water content on the cell morphology, PS/5% AC pellets were compressed with water and partially dried in an oven at varying times to make PS/5% AC pellets containing different loading levels of water. The water content was varied from 0, 0.5 to 1.5 wt %. The SEM micrographs of PS/5% AC foams are shown in FIGS. 8(a), 8(b), and 8(c), respectively. As expected, the foam made with dry PS/5% AC had smaller cell size. The extruded foam was thin and no qualified sample was collected for thermal conductivity measurements. In the presence of 0.5 wt % of water, the average cell size increased from 40 to 60 um (Table 2). The foam was thick enough for thermal conductivity testing. As can be seen in FIG. 8(c), there were more large cells when the water content increased to 1.5 wt %. However, the high moisture content made the cell size non-uniform. Additionally, water tended to act as a lubricant allowing the foam to exit the die very rapidly. Samples made under this condition were very thin and no qualified samples could be collected for thermal conductivity measurements. In this study, the 0.5 wt % water loading level provided stable extrusion and good foam samples. It is interesting to note that the PS/5% AC/0.5% water sample possesses a similar cell size to the PS/0.5% talc sample, but the cell density is twice as high due to the high AC content, therefore, the foam density is lower.

The effective thermal conductivity of foam is constituted of three components: conduction through solid, conduction through gas inside the cells, and radiation. A well accepted model was proposed by Schuetz et al. [23] as follows:

$${k}_{eff} = {k}_{g} + ( \frac{2}{3} - \frac{{f}_{s}}{3} ) ( 1 - δ ) {k}_{s} + \frac{16 σ {T}_{m}^{3}}{3 K}$$

where k_{eff} is the conductivity of foam, k_{g} is the thermal conductivity of cell gas, fₛ is the fraction of solid in struts, δ is the porosity of foam, kₛ is thermal conductivity of solid material, a is Stefan-Boltzman constant, Tₘ is the mean temperature between two plates and K is a mean extinction constant. Usually, conduction through gas contributes 60% of the overall thermal conductivity.

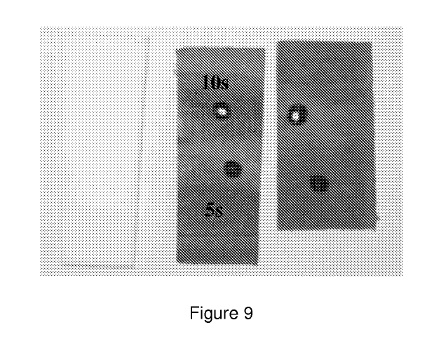

Conduction through solid and radiation conductivity vary with the foam density. A previous study [23] showed that radiation contributes 15% to 25% of the overall thermal conductivity when the density of the foam increases from 0.0296 to 0.0553 g/cm³. It is well known that carbon is a good IR absorber. During the measurement, the temperature of samples increased due to IR absorption. When the temperature was higher than the glass transition temperature, the foam collapsed and formed a cavity. The cavity size, corresponding to the heat produced by the IR absorption, increased with the IR exposure time. Therefore, the cavity size can qualitatively reflect the IR absorption level. The results of IR absorption are shown in FIG. 9. Comparing the three images in FIG. 9, the existence of cavities on the composite foam surface verifies the higher IR absorption caused by AC. Both PS/5% AC and 3% AC samples were burnt through with 10 sec IR exposure, however, there were larger cavities with PS/5% AC foam. These results indicate that PS/5% AC foam absorbs more energy than PS/3% AC foam.

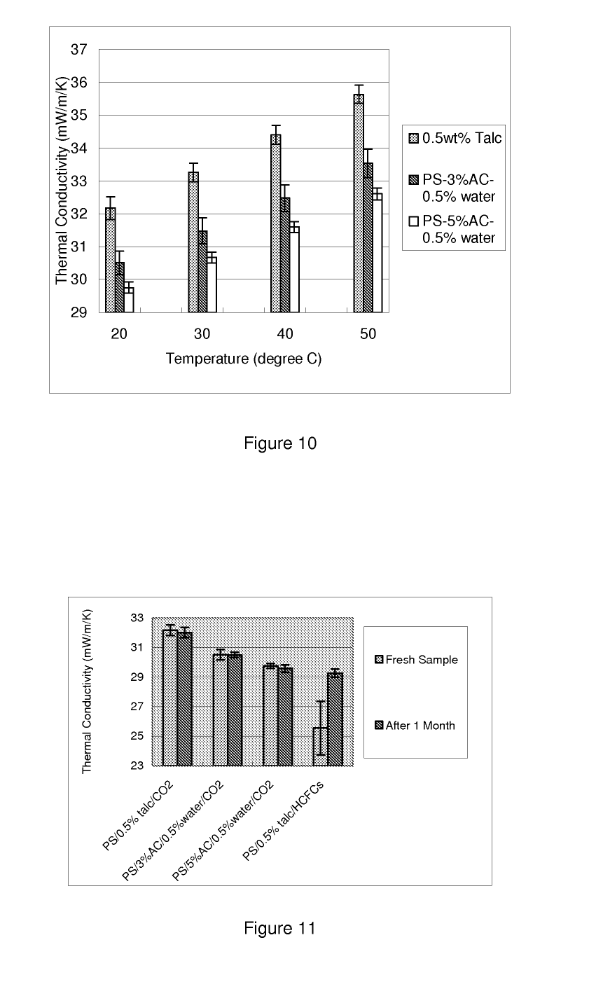

The results of thermal conductivity measurements are shown in FIG. 10. The thermal conductivity of PS/AC/water foam samples was significantly lower than that of PS/0.5% talc foam sample. This is due to the IR absorption of AC. PS/5% AC sample absorbs more IR than PS/3% AC sample, therefore, its thermal conductivity was lower. Additionally, the cell size of PS/3% AC foam was larger than that of PS/5% AC foam, although their foam density was the same. At the same foam density, heat transfer of the foam increases with the cell size when the cell size is less than 200 μm [22-25]. Lower thermal conductivity of PS/5% AC sample could be a combination of stronger IR absorption and smaller cell size.

Since 60% of the overall thermal conductivity comes from conduction through gas, a lower thermal conductivity of blowing agents may further lower the thermal conductivity of the foam. The thermal conductivities of HCFC-142b, HCFC-22, CO₂ and air are 11.5, 11.0, 16.6 and 25.7 mW/m/K at 25° C., respectively [26]. CO₂ or HCFCs will diffuse through the cell walls and cause the aging of foam, i.e., the thermal conductivity of the foam would increase with time. In this study, we tested the thermal conductivity of foams made with HCFCs, CO₂, and CO₂/water as fresh made and after one month of aging at room temperature. The thermal conductivities measured at 20° C. are reported in FIG. 11.

Thermal conductivities of samples foamed with CO₂ or CO₂/water did not change after fresh made, while that of samples foamed with HCFCs changed with time. Note that the fresh samples foamed with HCFCs show a large error bar because of time dependent diffusion within several hours after foaming. This may be attributed to 40% HCFC-22 in the HCFCs. Vo et al. [27] conducted a 25-year aging experiment to evaluate the long-term insulation effect of PS foamed with different blowing agents. Their results indicated that HCFC-22 is not suitable for long-term insulation applications since its effective diffusivity is two orders higher than that of HCFC-142b. In other words, HCFC-22 escapes the cells hundreds time faster than HCFC-142b. Consequently, samples foamed with mixed HCFCs used in our study showed a time dependent behavior in our study.

The effective diffusion coefficient of CO₂ is thousands time higher than that of HCFC-142b. CO₂ might diffuse out of the foam right after extrusion. A reference also showed that CO₂ was replaced by air within 30 days for a 2025 mm thick sample. Since the thickness of our sample was only 5-6 mm, it would take much less time for our sample to reach the equilibrium. Therefore, the thermal conductivity of our samples foamed with CO₂ did not change with time.

In summary, this example demonstrated that water can be compressed into PS/AC pellets at elevated temperature and pressure. In other exemplary embodiments, a liquid (e.g., water) into precursor material (e.g., PS/AC) material at a temperature at or below a softening temperature and at a pressure at or above atmospheric pressure. In the current example, water was introduced in the PS extrusion foaming process to lower the density of PS foams. Among the different methods studied in this example, compressing water into PS/AC pellets was most desirable since much less evaporation occurred during extrusion, and most of the water may serve as a co-blowing agent. PS/AC pellets with different AC and moisture loading levels were tested for extrusion foaming. A moisture content of 0.5 wt % seems to be the optimized content in our study. More than 0.5 wt %, water would make cell size non-uniform and cause extrusion instabilities. PS/5% AC foam possessed the lowest thermal conductivity among all samples because it had the smallest cell size and absorbed more IR than other samples at the same foam density. The residual CO₂ in the cell may not contribute to this difference since thermal conductivity remained the same in the aging experiment. Most of CO₂ may have escaped the cell since CO₂ possesses a high diffusion coefficient.

The following references are hereby incorporated herein by reference:
(1) Crevecoeur, J. J.; Nelissen, L.; Lemstra P. J. Polymer, 1999, 40, 3685-3689.
(2) Pallay, J.; Kelemen, P.; Berghmans, H.; Van Dommelen, D.; Macromol Mater Eng, 2000, 275, 18-25.
(3) Guo, Z. H.; Yang, J. T.; Wingert, M. J.; Shen, J.; Tomasko, D, L.; Lee, L. J. ANTEC, 2007, 3062-3065.
(4) C. A. Martinez-Perez, P. E. Garcia-Casillas, P. Romero, C. Juarez, C. A. Martinez-Villafane, A. D. Moller, J. Romero-Garcia, J of Adv Mater Special Ed 1, 5-11, (2006).
(5) R. H. Li, M. White, S. Williams, T. Hazlett, J of Biomater Sci, Polym Ed 9, 239 (1998).
(6) M. C. Wake, P. K. Gupta, A. G. Mikos, Cell Transplantation 5, 465 (1996).
(7) RP-120X Polymeric Foams—Updated Edition; Business Communications Company, Inc., December 2001.
(8) X. M. Han, J. Shen, H. X. Huang, D. L. Tomasko, L. J. Lee, Polym Eng Sci, 47, 103 (2007).
(9) L. J. Lee, C. C. Zeng, X. Cao, X. Han, J. Shen, G. J. Xu, Compos Sci Technol, 65, 2344 (2005).
(10) L. E. Daigneault, R. Gendron, J Cell Plast, 37, 262 (2001).
(11) J. T. Yang, S. K. Yeh, N. R. Chiou, Z. H. Guo, T. Daniel, L. J. Lee, SPE ANTEC 1013 (2008).
(12) J. J. Crevecoeur, L. Nelissen, P. J. Lemstra, Polymer, 40, 3685 (1999).
(13) J. J. Crevecoeur, L. Nelissen, P. J. Lemstra, Polymer, 40, 3691 (1999).
(14) J. J. Crevecoeur, L. Nelissen, P. J. Lemstra, Polymer, 40, 3697 (1999).
(15) G. Guiscard, K. Hahn; P. Dodel, U.S. Pat. No. 6,342,540 B1 (2002).
(16) J. Pallay; P. Kelemen, H. Berghmans, D. Van Dommelen, Macromol Mater Eng, 275, 18 (2000).
(17) J. Pallay, H. Berghmans, Cell Polym, 21, 1 (2002).
(18) J. Pallay, H. Berghmans, Cell Polym, 21, 19 (2002).
(19) J. Pallay, S. Pallayova, H. Berghmans, J Cell Plast, 43, 371 (2007).
(20) J. Shen, X. Cao, L. J. Lee, Polymer, 47, 6303 (2006).
(21) Z. H. Guo, J. T. Yang, M. J. Wingert, J. Shen, D. L. Tomasko, L. J. Lee, SPE ANTEC, 3062 (2007).
(22) L. J. Gibson, M. F. Ashby, Cellular Solids, Cambridge University Press, Chapter 7 (1999).
(23) L. R. Glicksman, Heat Transfer in Foams, in N. C. Hilyard et al., editor, Low Density Cellular Plastics, Chapman & Hall, New York, Chapter 5 (1994).
(24) O. M. Almanza, M. A. M. A. Rodriguez-Perez, J. A. De Saja, J Polym Sci Part B: Polym Phys, 38, 993 (2000).
(25) O. M. Almanza, M. A. Rodriguez-Perez, J. A. De Saja, Polym Int, 53, 2038 (2004).
(26) A. Albouy, J. D. Roux, D. Mouton, J. H. Wu, Cell Polym, 17, 163 (1998).
(27) C. V. Vo, A. N. Paquet, J Cell Plast, 40, 205 (2004).

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A method for making a foamed polymer comprising:
(a) preparing a foamable polymeric material precursor comprising:
i. a polymeric material selected from the group consisting of polystyrene, thermoplastic polymers, and polymer blends thereof;
ii. a foaming facilitating material having affinity for a liquid, said foaming facilitating material comprised of material selected from the group consisting of activated carbon, charcoal, and 1-dimensional, 2-dimensional, and 3-dimensional nano/micro-materials and mixtures of two or more thereof, said foaming facilitating material adapted to contain said liquid in the absence of any surfactant-like molecules or polymers;
iii. a blowing agent; and
iv. said liquid; and
(b) preparing a foamed polymer from said foamable polymeric material precursor.

2. A method according to claim 1 wherein said polymeric material is polystyrene.

3. A method according to claim 1 wherein said polymeric material is selected from the group consisting of polystyrene/PMMA blends, polystyrene/PPO blends, thermoplastic polyolefin (TPO), polystyrene/high-impact polystyrene (HIPS) blends, PMMA, HIPS, polyvinyl chloride (PVC), maleic anhydrid modified PP (poly propyl methacrylate (PPMA)), polyethylene vinyl acetate (PEVA), acrylonitrile butadiene styrene (ABS), acrylic celluloid, cellulose acetate, ethylene-vinyl acetate (EVA), ethylene vinyl alcohol (EVAL), fluoroplastics (e.g., PTFE, FEP, PFA, CTFE, ECTFE, and ETFE), ionomers, Kydex (i.e., a trademarked acrylic/PVC alloy), liquid crystal polymer (LCP), polyacetal (e.g., POM and acetal), polyacrylates (acrylic), polyacrylonitrile (e.g., PAN and acrylonitrile), polyamide (e.g., PA and nylon), polyamide-imide (PAI), polyaryletherketone (e.g., PAEK and ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), polysulfone, polyethylene chlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC), spectralon, or a mixture thereof.

4. A method according to claim 1 wherein:
said polymeric material is polystyrene; and
said foaming facilitating material comprises activated carbon.

5. A method according to claim 1 wherein said foaming facilitating material and said polymeric material are present in a weight ratio in the range of from about 20% to about 0.01%.

6. A method according to claim 1 wherein said foaming facilitating material comprises a 1-dimensional nano/micro-material selected from the group consisting of smectite clays, organoclays, nanographites, graphite, graphene, and graphene oxide.

7. A method according to claim 1 wherein said foaming facilitating material comprises a 2-dimensional nano/micro-material selected from the group consisting of carbon nanofibers, multi-wall carbon nanotubes, single wall carbon nanotubes, conducting polymer nanofibers and nanotubes, and polymer nanofibers/nanotubes.

8. A method according to claim 1 wherein said foaming facilitating material comprises a 3-dimensional nano/micro-material selected from the group consisting of quantum dots, polyoctahedralsilasesquioxanes (POSS), silica, and TiO₂, ZnO, and Fe₃O₄ nanoparticles.

9. A method according to claim 1 wherein said blowing agent is selected from the group consisting of CO₂, N₂, hydrofluorocarbons, fluorocarbons, and mixtures thereof.

10. A method according to claim 1 wherein said blowing agent is CO₂.

11. A method according to claim 1 wherein said liquid is introduced into said polymeric material and said foaming facilitating material by exposing a solid combination of said polymeric material and said foaming facilitating material at a temperature below or above a softening temperature and at a pressure at or above atmospheric pressure for sufficient time to introduce said liquid into said foaming facilitating material.

12. A method according to claim 1 wherein said liquid is selected from the group consisting of hydrocarbons, halogenated hydrocarbons, alcohols, dihydric alcohols, polyhydric alcohols, ketones, esters, ethers, amides, acids, aldehydes, water, and mixtures thereof.

13. A method according to claim 1 wherein said liquid is water.

14. A method according to claim 1 wherein said liquid is selected from the group consisting of alcohols.

15. A method according to claim 1 wherein said foamable polymeric matieral precursor is substantially free of any surfactant-like molecules or polymers.

16. A method according to claim 1 wherein said foamed polymer is prepared by a process selected from the group consisting of extrusion, batch molding, and injection molding.

17. A method according to claim 1 wherein said foamable polymeric material precursor has cells that contain said blowing agent and/or said liquid.

18. A method according to claim 1 wherein said foamed polymer has cells that are of an average size less than 200 micrometers.

19. A method according to claim 1 wherein said foamed polymer has cells that are of an average size less than 10 micrometers.

20. A method according to claim 1 wherein said foamed polymer has cells that are of an average size less than 0.10 micrometers.
